(19) United States
(12) Patent Application Publication
(10) Pub. No.: US 2007/0096371 A1
(43) Pub. Date: May 3, 2007

(54) PROCESS OF PRODUCING CERAMIC MATRIX COMPOSITES

(75) Inventors: Henry Charles McGuigan, Duanesburg, NY (US); Gregory Scot Corman, Ballston Lake, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/163,699

(22) Filed: Oct. 27, 2005

(51) Int. Cl. B29C 33/58; B28B 3/00; C04B 33/32; B28B 1/00; B28B 5/00; C04B 35/64; C04B 33/36

(52) U.S. Cl. 264/640; 264/650; 264/316

(57) ABSTRACT

A process for producing CMC articles, such as turbine components. The process entails applying a release sheet to a drum and then forming on the drum an impregnated tape that overlies the release sheet. The tape comprises a slurry mixture containing a ceramic precursor material and a unidirectionally-oriented filamentary material that may be wound onto the drum dry or already impregnated with the mixture. A second release sheet may be applied to overlie the tape. Alternatively, the filamentary material may be impregnated with the slurry mixture after it has been wound and removed from the drum. The resulting laminate structure may then be passed through an apparatus that flattens the tape and redistributes the slurry mixture within the tape.

This invention was made with Government support under Agreement No. DE-FC02-92CE41000 awarded by the Department of Energy. The Government has certain rights in the invention.

### BACKGROUND OF THE INVENTION

The present invention generally relates to ceramic matrix composite (CMC) articles. More particularly, this invention is directed to a process of producing melt-infiltrated (MI) CMC articles that includes processing steps capable of yielding prepreg tapes with improved physical and mechanical properties, thereby enabling the production therefrom of CMC articles that exhibit improved physical, mechanical, and microstructural properties.

Higher operating temperatures for gas turbine engines are continuously sought in order to increase their efficiency. Though significant advances in high temperature capabilities have been achieved through formulation of iron, nickel and cobalt-base superalloys, alternative materials have been investigated. Notable examples include ceramic matrix composite (CMC) materials, whose high temperature capabilities are capable of significantly reducing cooling air requirements. CMC materials, particularly continuous fiber ceramic composite (CFCC) materials, are currently being considered for shrouds, combustor liners, nozzles, and other high-temperature components of gas turbine engines. Of particular interest to high-temperature applications are silicon-based composites, such as silicon carbide (SiC) as the matrix and/or reinforcement material.

CMC materials generally comprise a fibrous or filamentary reinforcement material embedded in a ceramic matrix material. The reinforcement material serves as the load-bearing constituent of the CMC in the event of a matrix crack, while the ceramic matrix protects the reinforcement material, maintains fiber orientation, and serves to dissipate loads to the reinforcement material. CMC's are frequently fabricated from multiple layers of “prepreg,” which is typically a tape-like structure comprising the reinforcement material impregnated with a slurry that contains a precursor of the matrix material and one or more organic binders. The prepreg tape must undergo processing (including firing) to convert the precursor to the desired ceramic. Prepregs for CFCC materials frequently comprise a two-dimensional fiber array comprising a single layer of unidirectionally-aligned tows (bundles of individual filaments) impregnated with a matrix precursor to create a generally two-dimensional laminate. Multiple plies of the resulting prepregs are then stacked and debulked to form a laminate preform, a process referred to as “lay-up.” The prepregs are typically but not necessarily arranged so that tows of adjacent prepregs are oriented transverse (e.g., perpendicular) to each other, providing greater strength in the laminar plane of the preform (corresponding to the principal (load-bearing) directions of the final CMC component).

Following lay-up, the laminate preform will typically undergo debulking and curing while subjected to applied pressure and an elevated temperature, such as in an autoclave. In the case of melt-infiltrated (MI) CMC articles, the debulked and cured preform undergoes additional processing. First the preform is heated in vacuum or in an inert atmosphere in order to decompose the organic binders, at least one of which pyrolyzes during this heat treatment to form a carbon char, and produces a porous preform for melt infiltration. Further heating, either as part of the same heat cycle as the binder burn-out step or in an independent subsequent heating step, the preform is melt infiltrated, such as with molten silicon supplied externally. The molten silicon infiltrates into the porosity, reacts with the carbon constituent of the matrix to form silicon carbide, and fills the porosity to yield the desired CMC component. As an example, FIG. 1 represents a surface region of a CMC component 10 as comprising multiple laminae 12, each the result of individual prepreg sheets. Each lamina 12 contains a ceramic reinforcement made up of unidirectionally-aligned fibers 17 encased in a ceramic matrix 14 formed by conversion of the ceramic matrix precursor during firing.

A step in the typical method for making prepreg MI-CMC preforms is to use a wet drum winding technique to form the fiber tows into a unidirectional prepreg tape, which is then used for lay-up of the composite preform. As represented in FIG. 2, typical wet drum winding processes entail pulling fiber tow 16 through a bath 18 containing a slurry mixture that includes suitable matrix precursor materials, organic binders, and solvents, and then winding the resulting precursor-impregnated tow 20 around a drum 22. Before contacting the drum, the precursor-impregnated tow 20 is preferably pulled through an orifice 24 to control the amount of slurry picked up by the tow 16. By indexing the drum 22 (and/or the bath 18 and orifice 24), the tow 20 is laid down at a constant pitch so that each tow winding touches but does not completely overlap the tow winding from the previous drum revolution, yielding a continuous, unidirectional prepreg tape. Prior to being wound with the tow 20, the drum 22 is preferably wrapped with a release sheet 26, such as a film formed of TEFLON® (polytetrafluoroethylene, or PTFE), so that the resulting prepreg tape can be more easily removed from the drum 22. The release sheet 26 also acts as a carrier to support the prepreg during subsequent handling and cutting. While on the drum 22, the prepreg tape is typically allowed to air dry by allowing the solvents to evaporate. Alternatively, the tape may be cut from the drum 22, laid flat, and allowed to air dry.

Prepreg tapes produced by wet drum winding processes typically have a surface roughness, or waviness, corresponding to the pitch of the fiber tow 16 on the drum 22. There is also variability in the distribution of fiber and matrix across the tape because of the tow pitch. Furthermore, because the tow 16 is under tension during the winding process, the tow 16 tends to be pulled down onto the drum surface, yielding a prepreg tape that has proportionally more tow 16 at the surface of the tape contacting the drum 22 and proportionally more matrix precursor at the surface of the tape facing away from the drum 22. Because the pliability, or drapability, of the resulting prepreg tape is highly dependent on its residual solvent content, there is a limited time window from when a tape is wound to when the tape must be utilized in a composite preform lay-up. For example, after about twelve hours at ambient conditions, tapes can become too stiff and lose tackiness to allow for a consistent lay-up of the composite plies.

Typical wet drum winding processes can also suffer from a significant amount of broken tow fibers and loosely adhering fibers (i.e., “fuzz”) that can break off and cause blockage of the orifice 24. When blockage occurs, the amount of slurry remaining on the tow 16 downstream of the orifice 24 is diminished, leading to a region on the resulting prepreg tape with lower than optimum matrix content. In severe cases the blockage of the orifice 24 can continue to accumulate broken fiber from the tow 16 until it eventually causes the tow 16 to break. In order to prevent such problems from blockage, the orifice 24 is typically sufficiently sized to allow a majority of tow 16, even those with moderate amounts of damaged fiber and adhering loose fiber, to readily pass. Consequently the amount of matrix picked up by the tow 16 may be higher than would be optimum, thus leading to lower than desired fiber volume fraction in the finished composite. Even with the use of a large orifice 24, orifice blockage can still occur. Consequently, drum winding operations require constant operator supervision so that such blockages can be removed as they occur.

Another complication of conventional drum winding processes is that the tow 16 must be completely impregnated (i.e., wet out) with slurry during the winding process, which requires that the tow 16 spend a sufficient amount of time submersed in the slurry to allow for complete wet out. This submersion time, which can be about five seconds for certain processes, places a limit on the speed with which the tow 16 can be drawn through the slurry bath. Consequently the time necessary to drum wind a 100 meter tow can be on the order of about thirty minutes.

In view of the above, improvements in drum winding processes for producing CMC products would be highly desirable.

### BRIEF SUMMARY OF THE INVENTION

The present invention provides a process for use in the production of CMC articles, such as components of gas turbine engines. The invention is particularly directed to a drum winding process capable of promoting the physical and mechanical properties of a prepreg tape, and thereby enable the production therefrom of CMC articles that exhibit improved physical, mechanical, and microstructural properties.

According to one aspect of the invention, steps carried out to produce a CMC article entail applying a first release sheet to a drum and then forming on the drum an impregnated tape that overlies the first release sheet. The impregnated tape comprises a filamentary material unidirectionally oriented within the impregnated tape and a slurry mixture consisting of a ceramic precursor material and additional constituents that are nonreactive to the first release sheet. A second release sheet is then applied to overlie the impregnated tape, with the result that the impregnated tape is between the first and second sheets to yield a laminate structure. As with the first release sheet, the second release sheet is also nonreactive to the constituents of the slurry mixture carried by the filamentary material. The laminate structure is then passed through an apparatus that flattens the impregnated tape and redistributes the slurry mixture within the impregnated tape.

According to another aspect of the invention, the filamentary material can be wound onto the drum after or before being impregnated with the slurry mixture. If the former, the impregnated tape is formed in situ on the drum. If the latter, the impregnated tape can be formed in situ on the drum by impregnating the filamentary material with the slurry mixture while still on the drum or after the filamentary material has been removed from the drum in the form of a filamentary mat, in which case the first release sheet carries an adhesive that adheres the filamentary material together on the drum so that the filamentary mat can be removed and impregnated with the slurry mixture without disrupting the filamentary material.

According to the first aspect of the invention, the operation of flattening the tape and redistributing the slurry mixture within the tape is able to improve the uniformity of the matrix and fiber distribution in the tape, improve tape thickness uniformity, and improve the shelf life of the tape. More particularly, this operation decreases tape surface roughness yielding a more uniform tape thickness that aids in the lay-up process, compacts the tape to force out air entrapped within the tape and thereby removes a potential source of preform porosity, and redistributes the ceramic precursor material more evenly to the two surfaces of the tape thereby improving the matrix-to-fiber uniformity between the two surfaces which aids in the subsequent lamination process and yields a composite preform with a more uniform distribution of fiber throughout the matrix. The operation performed by the apparatus also effectively traps the tape between the two release sheets, which protects the tape from contamination and reduces the evaporation rate of solvents within the tape to increase the shelf life of the tape.

According to the second aspect of the invention, by winding the filamentary material onto the drum in a dry condition, fuzzy or damaged tows can be used that would otherwise not be suitable if pre-impregnated with slurry before winding on the drum. More particularly, by winding tow in the dry state, broken and fuzzy filaments have been found to be less likely to plug an orifice used to control the position of the tow during winding. Furthermore, the speed of the tow is not limited by the requirement to completely wet-out the tow with the slurry upstream of the winding operation. Impregnating the tow following winding also offers the ability of more accurately controlling the amount of slurry impregnated into the tow, such as impregnating the tow with the minimum amount of slurry necessary to fully wet-out and cover the tow, yielding a prepreg tape of minimal thickness and a high fiber volume fraction.

Other objects and advantages of this invention will be better appreciated from the following detailed description.

### BRIEF DESCRIPTION OF THE DRAWINGS

FIG. 1 is a cross-sectional representation of a CMC article of a type that can be produced with the process of the present invention.

FIG. 2 schematically represents a drum winding apparatus of a type known in the art and capable of use with the present invention.

FIG. 3 is a cross-sectional representation of a laminated structure comprising an impregnated tape between two release sheets and produced in a process according to a first embodiment of the present invention.

FIG. 4 schematically represents the laminated structure of FIG. 3 passing between a pair of rollers to compress and flatten the structure and the tape within.

FIG. 5 is a stress-strain plot of data obtained from tensile tests comparing composite panels produced by a prior art practice and the process of the first embodiment of this invention.

FIG. 6 is a stress-strain plot of data obtained from tensile tests comparing composite panels produced by a prior art practice and a process in accordance with a second embodiment of this invention.

### DETAILED DESCRIPTION OF THE INVENTION

The present invention is generally applicable to CMC components, and particularly CFCC components. Notable examples of such components include combustor components, high pressure turbine vanes, and other hot section airfoils and components of gas turbine engines, though the invention has application to other components, including advanced power generation steam turbines and various other equipment that can make use of CMC components. Examples of CMC materials to which the invention pertains include those with a silicon carbide, silicon nitride and/or silicon reinforcement material in a ceramic matrix of silicon carbide, silicon nitride and/or silicon, e.g., a SiC/SiC CMC, though the invention also applies to other types of CMC materials. Examples of such materials and components are disclosed in commonly-assigned U.S. Pat. Nos. 6,024,898, 6,258,737, and 6,503,441, the contents of which relating to CMC materials and processing steps are incorporated herein by reference.

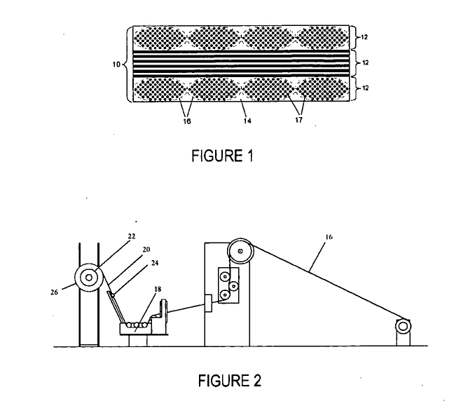

FIG. 1 is a representative cross-sectional view of a CFCC component 10 having a laminate construction comprising multiple layers (laminae) 12, each generally containing tows 16 in a ceramic matrix material 14. As known in the art, the tows 16, preferably in the form of sets of fiber bundles, serve as a reinforcement material to the matrix material 14. As noted above, particularly suitable materials for both the tows 16 and matrix material 14 include silicon carbide, silicon nitride, and/or silicon, though other materials are possible. As a CFCC component 10, the tows 16 are preferably unidirectional in each lamina 12, i.e., oriented side-by-side and parallel to each other. Suitable tow diameters and center-to-center tow spacings will depend on the particular application, the thicknesses of the laminae 12, and other factors, and therefore are not represented to scale in FIG. 1. According to known practice, the individual fibers 17 of the tows 16 are preferably coated with a release agent (not shown), such as boron nitride (BN) or carbon, which allows for limited and controlled slip between the fibers 17 and the ceramic matrix material 14. As cracks develop in the component 10, one or more fibers 17 bridging the crack act to redistribute the load to adjacent fibers 17 and regions of the matrix material 14, thus inhibiting or at least slowing further propagation of the crack.

In the fabrication of the component 10, a desired number of prepreg tapes are laid-up to form a preform (not shown) that undergoes further processing to yield the component 10. Each tape is formed to contain a reinforcement architecture (formed by the fibers 17) with a precursor of the desired matrix material 14, e.g., SiC, C, and/or other carbon-containing particulate material if the desired matrix material is SiC. According to conventional practice, such prepreg tapes are formed in a single operation by applying the precursor-containing slurry during winding of a continuous strand of tow 16 onto a drum 22, as previously described in reference to FIG. 1. Various slurries are known for this purpose, with a typical slurry composition containing, in addition to the desired ceramic precursor(s), one or more organic binders that can be pyrolyzed to form a carbon char (for example, furanic resins, phenolic resins, and polyvinylbutyral), and solvents for the binders (for example, toluene and/or MIBK). Preferred compositions for the precursor will depend on the particular composition desired for the ceramic matrix material 14 of the component 10. Following the winding operation, the slurry would be allowed to partially dry, and the resulting prepreg tape removed from the drum 22, laid-up with other tapes, and then debulked and cured while subjected to elevated pressures and temperatures. The resulting preform will often then undergo additional heating and infiltration, such as with molten silicon supplied externally, to reduce porosity and convert the ceramic precursor, thereby forming the ceramic matrix material 14 and yielding the desired component 10. Specific processing techniques and parameters will depend on the particular composition of the materials, and therefore will not be discussed here.

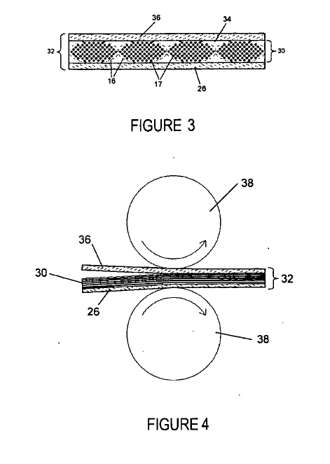

The present invention is primarily concerned with the winding operation, and therefore generally diverges from the process described above with respect to the manner in which the prepreg tape is processed prior to composite lay-up. According to a first aspect of the invention, after impregnation of a dry tow 16 with the desired slurry to yield an impregnated tow 20 (as described in reference to FIG. 2), the resulting impregnated tape is allowed to dry on the drum 22 for a limited time, for example, about twenty minutes or so. The tape, along with the release sheet 26 previously described as inhibiting adhesion of the tape to the drum 22, is removed from the drum 22. Contrary to conventional practice, the tape is then covered with a second release sheet, yielding a laminated structure 32 illustrated in FIG. 3 as comprising the impregnated tape 30 (containing the tows 16 and slurry 34) and release sheets 26 and 36. Suitable materials for the sheets 26 and 36 include TEFLON® (polytetrafluoroethylene, or PTFE) or another polymeric film material that is stable (chemically nonreactive) with the constituents of the slurry 34. The purpose of the second release sheet 36 is to slow the rate of solvent evaporation from the slurry 34 and trap some of the solvent vapors with the sheet 26. The effect is to homogenize the solvent content of the tape 30 through its thickness and across its width.

The laminate structure 32 is preferably allowed to stabilize, such as for about fifteen minutes or so, after which the entire structure 32 is passed through a rolling mill (as represented in FIG. 4) or other apparatus capable of compressing and flattening the structure 32 and the tape 30 within. The roll gap between a pair of rollers 38 of the mill is preferably set to slightly compress the tape 30 while passing between the rollers 38. For example, a tape 30 produced to contain 500-filament HI-NICALON® fiber tow commercially available from Nippon Carbon Co., Ltd., wound at a pitch of 0.045 inch (about 1.1 mm) with a slurry orifice 24 of 0.038 inch (about 1 mm) to yield a tape thickness of about 0.012 to about 0.013 inch (about 0.30 to 0.33 mm), can be compressed with the rollers 38 set to a gap thickness of about 0.008 inch (about 0.20 mm) plus the thickness of the two release sheets 26 and 36. The laminate structure 32 is preferably fed slowly through the rollers 38 at a relatively low rate, such as up to about four inches (about 10 cm) per second, more preferably about 1 to about 2 inches (about 2.5 to 5 cm) per second, with the direction of feed through the rollers 38 being parallel to the direction of the fibers 17, or tows 16, in the prepreg tape 30. Preferably, the structure 32 is then flipped over and run through the rollers 38 a second time. Preferred speeds at which the structure 32 is processed in this manner are sufficiently low to promote forcing of any air trapped within the tape 30 out through the edges of the tape 30. Care should be taken during the rolling process to avoid any wrinkles or folding of the tape 30 and sheets 26 and 36. As a result of this procedure, the tape 30 is effectively sealed between the two sheets 26 and 36.

Before being laid-up with other tapes, the tape 30 is typically cut to the desired ply shape for the intended component 10 while still captured between the sheets 26 and 36. The structure 32 can then be cooled by placing in a freezer or dipping in a cooling liquid such as liquid nitrogen until the tape 30 becomes hard and sufficiently loses its tackiness to permit the sheets 26 and 28 to be easily removed. Thereafter, the tape 30 can be permitted to warm to room temperature, restoring some of its tackiness to facilitate the lay-up process. According to a preferred embodiment of the invention, the pliability and tackiness of the tape 30 can be further increased by applying to the surfaces of the tape 30 a thin coating of a mixture containing a solvent and binder, the latter of which is preferably an organic binder of the slurry 34 used to form the tape 30. An example of such a mixture contains about 50% by volume of both acetone and a resin commercially available under the name Cotronics 980. The mixture can be applied to the tape surface and any excess wiped off, for example, with a squeegee.

Absorption of the binder-solvent mixture into the tape 30 replaces some of the binder and solvent that are inherently lost during exposure and storage of the tape 30, particularly along the edges of the tape 30. The increased pliability and tackiness resulting from this re-wetting step further aid in the lay-up of the tape 30 with other similarly processed tapes to form a composite preform, particularly if the preform is to have curved surfaces or complex features. If other tapes have been stored for different durations or under different conditions that result in different levels of dryness, the application of the binder-solvent mixture increases the consistency between tapes and reduces thickness variations that could otherwise lead to inconsistencies in the thickness of the composite preform following lamination. Re-wetting of the tape 30 in this manner is also believed to promote more uniform shrinkage of the tape 30 during subsequent processing by filling in any regions of the tape 30 containing relatively low levels of precursor, thereby yielding a more consistent preform.

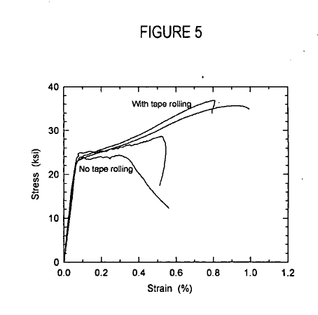

The above process was reduced to practice during experiments performed to assess the effects of tape rolling on the performance of composites. FIG. 5 shows a stress-strain plot from a tensile test performed on two CMC panels that were processed identically, with the exception that the processing of one of the panels included a rolling operation. The CMC panels were processed using HI-NICALON® fiber tow coated via chemical vapor deposition (CVD) with a multilayer coating consisting of BN, carbon, silicon nitride, and carbon. The tow was formed into two prepreg tapes using the wet drum winding process described earlier with a matrix slurry containing about 25% SiC powder and about 11% carbon powder as ceramic precursor, about 16% organic binders, and about 48% solvents for the binders. The tows were wound at a feed rate of about 122.5 inches (about 311 cm) per minute and at a pitch of 0.045 inch (about 1.1 mm) onto a drum covered with an approximately 0.005 inch (about 0.13 mm) thick PTFE film. After winding, the tapes were allowed to dry on the drum for approximately fifteen minutes and then removed from the drum. One of the tapes was allowed to dry further whereas the other was loosely covered with a second sheet of PTFE film and allowed to equilibrate for approximately fifteen minutes. The covered tape was then fed through a roller mechanism at a speed of approximately 0.5 inch (about 1.3 cm) per second, with a roller gap setting of about 0.018 inch (about 0.46 mm). The thickness of the prepreg tape prior to rolling, as measured with digital calipers, was approximately 0.013 inch (about 0.33 mm), and after rolling it was approximately 0.0115 inch (about 0.29 mm). Both of the tapes were then cut into individual ply shapes, stacked into identical 0-90 fiber architectures, and then vacuum bag laminated in an autoclave at about 125° C. and at an autoclave pressure of about 70 psi (about 0.5 MPa) for about eighteen hours. Both panels, now in the form of compacted preforms, were then heated to about 700° C. in a vacuum furnace at a heating rate of about 0.75° C./minute, held at about 700° C. for about thirty minutes, and then cooled to room temperature. An aqueous slurry was prepared containing a mixture of, by weight, about 91% silicon powder, about 6% BN powder, and about 3% boron powder in a solution of 2% Duramax D-3005 dispersant in water. The slurry, having the consistency of a thick paste, was then spread over the surfaces of both panels by hand, and the panels with their slurry coatings allowed to dry at about 60° C. for about eighteen hours. The coated preform panels were then heated in a vacuum furnace at a rate of about 5° C./minute to about 1435° C. and held there for about thirty minutes. At this temperature the silicon and boron in the slurry coating melted and wicked into the preform panels via capillarity. The panels were then cooled to room temperature and remnants of the Si+BN+B mixture were removed by grit blasting with 220 grit alumina. Two tensile test samples were cut from each panel and tensile tested to failure at room temperature, the resulting stress-strain curves of which are shown FIG. 5. From FIG. 5, it can be seen that there was a clear improvement in ultimate strength and strain-to-failure in the rolled specimen, which was attributed to microstructural improvements resulting from the tape rolling operation.

In addition to the improvements noted above, further processing improvements are believed to be attainable if the tow 16 is wound onto the drum 22 in a dry state (i.e., without impregnation with the slurry or other precursor-containing composition). By winding only the tow 16 onto the drum 22, the result is a mat comprising unidirectionally-aligned dry tows 16 that can be impregnated with the slurry while on the drum 22 or after the mat is removed from the drum 22. In the latter case, the release sheet 26 preferably carries an adhesive on its surface facing the tow 16 so that the individual strands of tow 16 are held together and the mat can be removed from the drum 22 without disturbing the tow 16. Similar to the re-wetting step described above, impregnation of the dry mat can be achieved by applying the slurry to the mat using a squeegee, a doctor blading operation, etc. Thereafter, the resulting tape can undergo flattening and compaction as described previously in accordance with the present invention.

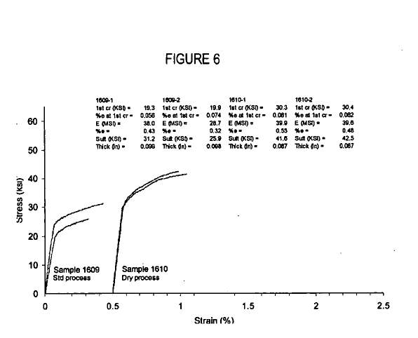

The dry winding technique of this invention described above was investigated with a sample of HI-NICALON® tow that had been extensively damaged to the extent that conventional wet drum winding was found to be extremely difficult due to plugging of the slurry orifice. The tow was wound dry over a TEFLON® release sheet onto a drum at a pitch of about 0.045 inch (about 1.1 mm) with no orifice plugging problems. The wrapped tow was then adhesively attached to the release sheet at regular intervals to permit the sheet and tow to be removed as a unitary mat from the drum. The mat was then flattened, and a matrix slurry having the same composition as that of the previous investigation was then poured onto the mat and worked into the unidirectional tow by hand with a plastic squeegee. After drying, the now-impregnated tape was removed from the release sheet and used to lay-up an 8-ply 0-90 composite, which was subsequently autoclave laminated, burned-out and infiltrated using standard practices. Another sample of the same HI-NICALON® tow (with similar damage) was used to produce additional composites in the same manner, but using a conventional wet winding process to apply the slurry directly to the tow prior to winding. The experimental composite made using the dry winding process was thinner than the composite produced by the wet winding process, with the result that the experimental composite had a higher fiber volume fraction. The resulting composites were then tensile tested at room temperature, with the resulting stress-strain curves shown in FIG. 6. The higher fiber volume fraction of the experimental composite (Sample 1610) is reflected in its higher ultimate strength (over 40 ksi (about 280 MPa)) compared to the conventional composite (Sample 1609) made from the standard wet winding process (average of about 28.5 ksi (about 195 MPa). The experimental composite was also found to have fewer microstructural defects, evidenced by its higher proportional limit stress (about 30 ksi versus about 19.5 ksi (about 210 MPa versus about 135 MPa)).

While the invention has been described in terms of particular embodiments, it is apparent that other forms could be adopted by one skilled in the art. Accordingly, the scope of the invention is to be limited only by the following claims.

What is claimed is:

1. A process of producing a ceramic matrix composite article, the process comprising:
applying a first release sheet to a drum;
forming an impregnated tape that overlies the first release sheet, the impregnated tape comprising a filamentary material unidirectionally oriented within the impregnated tape and a slurry mixture containing a ceramic precursor material;
applying a second release sheet to overlie the impregnated tape so that the impregnated tape is between the first and second release sheets to yield a laminate structure; and then passing the laminate structure through an apparatus that flattens the impregnated tape and redistributes the slurry mixture within the impregnated tape.

2. A process according to claim 1, wherein the ceramic precursor material of the slurry mixture comprises silicon carbide particulate, carbon particulate, and/or mixtures thereof.

3. A process according to claim 1, wherein the filamentary material comprises a ceramic fiber material.

4. A process according to claim 1, wherein the apparatus comprises a roller that rotates while contacting and applying pressure to the laminate structure during the passing step.

5. A process according to claim 1, wherein the first and second release sheets reduce the evaporation rate of the constituents of the slurry mixture from the laminated structure.

6. A process according to claim 1, wherein the apparatus forces entrapped air from the impregnated tape.

7. A process according to claim 1, wherein the forming step comprises impregnating the filamentary material with the slurry mixture and then winding the precursor-impregnated filamentary material onto the drum so as to form the impregnated tape in situ on the drum.

8. A process according to claim 1, wherein the forming step comprises winding the filamentary material onto the drum without the slurry mixture, and then impregnating the filamentary material with the slurry mixture while the filamentary material is on the drum so as to form the impregnated tape in situ on the drum.

9. A process according to claim 8, wherein the filamentary material is dry during the winding step.

10. A process according to claim 9, wherein the first release sheet carries an adhesive that adheres the filamentary material thereto.

11. A process according to claim 1, wherein the slurry mixture further comprises a solvent and at least one organic binder capable of being pyrolyzed to form a carbon char.

12. A process according to claim 1, further comprising the steps of:
removing the first and second release sheets from the impregnated tape;
laying-up the impregnated tape with at least a second impregnated tape produced by the process of claim 1 to yield a laminate preform; and then
heating and melt infiltrating the laminate preform to convert the ceramic matrix precursor to a ceramic matrix material and thereby yield a ceramic matrix composite comprising multiple laminated layers.

13. A process according to claim 12, further comprising the step of applying a mixture of a solvent and an organic binder to surfaces of the impregnated tape to soften and increase tackiness of the impregnated tape prior to the laying-up step.

14. A process according to claim 12, wherein the ceramic matrix composite article is a component of a turbine.

15. A process of producing a ceramic matrix composite article, the process comprising:
applying a release sheet to a drum;
dry-winding a filamentary material onto the drum without a slurry mixture, the release sheet carrying an adhesive that adheres the filamentary material together on the drum to form a filamentary mat; and then
impregnating the filamentary mat with a slurry mixture without disrupting the filamentary material so as to yield an impregnated tape on the release sheet.

16. A process according to claim 15, further comprising removing the filamentary mat from the drum before the impregnating step.

17. A process according to claim 15, further comprising removing the filamentary mat from the drum after the impregnating step.

18. A process according to claim 15, further comprising passing the laminate structure through an apparatus that flattens the impregnated tape and redistributes the slurry mixture within the impregnated tape.

19. A process according to claim 15, wherein the slurry mixture contains a ceramic precursor material and an organic binder.

20. A process according to claim 19, further comprising the steps of:
removing the release sheet from the impregnated tape;
laying-up the impregnated tape with at least a second impregnated tape produced by the process of claim 19 to yield a laminate preform; and then
heating and melt infiltrating the laminate preform to convert the ceramic matrix precursor to a ceramic matrix material and thereby yield a ceramic matrix composite comprising multiple laminated layers.
